(19) United States
(12) Patent Application Publication
(10) Pub. No.: US 2025/0272867 A1
(43) Pub. Date: Aug. 28, 2025

(54) CV BRIDLE MONITOR AND MOBILATOR SENSING SYSTEM

(71) Applicant: TAIT TOWERS MANUFACTURING, LLC, Lititz, PA (US)

(72) Inventor: James D. LOVE, Lititz, PA (US)

(21) Appl. No.: 18/583,983

(22) Filed: Feb. 22, 2024

(51) Int. Cl. G06T 7/70; G06T 7/292

(52) U.S. Cl. CPC G06T 7/70; G06T 7/292; G06T 2207/10012

(57) ABSTRACT

A system for monitoring the position of a mobile element on a performance stage in real time including a computer vision camera that captures images while the mobile element moves into multiple positions about the stage and converts the images to position data, and control system directing movement of the mobile element using position data.

### FIELD OF THE INVENTION

The present disclosure is generally directed to control of mobile elements of a stage and, more particularly, to the use of computer vision (CV) cameras mounted on the mobile elements to determine position in relation to stationary or other moving elements on the stage.

### BACKGROUND OF THE INVENTION

As well as complex lighting design and sound design, the modern touring music and entertainment industry employs highly complex staging and set design in order to deliver engaging and entertaining shows, concerts or gigs. The staging may involve complex moving parts, for example in order to convey artists, musical equipment, lighting equipment or other stage equipment during the course of the performance.

Motion automation systems using mobile platforms propelled on a stage while supporting persons, objects, or equipment, or multiple winches to suspend and animate flying movement of persons, objects, or equipment is well known. More recent innovations in such motion animation systems incorporate distributed control features to spread control processing computations among the on-board controls for individual motion elements to provide greater computational bandwidth at the motion automation system.

It is common for even the most complex shows to be repeated in consecutive nights in different venues. Accordingly, there is a need for these complex staging systems to be rapidly assembled before the show, rapidly dissembled after the show and suitable for packing down in a compact manner for transport between venues, by road, air or boat. There is also a need for the rigging and other systems for the show to be calibrated before each performance.

In addition, even for large shows it is typical for a small number of staff to travel with the show to oversee the assembly, disassembly and packing down of the staging, with the bulk of the labor being carried out by locally-hired staff. The locally-hired staff are unlikely to be familiar with the specific staging set-up of the particular show and will have a very limited window of time to become familiar with the way in which the staging is to be assembled. This can be exacerbated in international touring, where the locally-hired staff may not speak the same language as the touring staff.

One method for motion control of a mobile element on a stage is to provide a track embedded in the stage and provide sensors for detecting the track on the mobile element. The mobile element is then guided by the sensors and track to move the mobile element along a desired path defined by the track. Mobile element position on the stage is determined by sensing its position along the track.

Another method requires defining the desired path in a master stage motion control system and allowing the control system to direct movement of the mobile element though an umbilical or wireless link connected to the control system. While such control systems may include position inputs for stage elements, they generally lack the control precision needed to control the mobile element.

Another method of position detection and motion control and of a mobile element is to provide a RF positioning system comprising a plurality of transmitters on the stage and a position receiver on the mobile element which enables its position to be calculated by triangulating the transmitter signals. RF-based positioning systems generally do not the positioning accuracy, especially compared to CV-based systems.

Other automation systems require active beacons on the payload to be able to track the payload position.

Each of these systems requires precise positioning of the guide track and/or other elements on the stage to avoid interference with the mobile element as it is directed along a planned path and increase the time necessary to set up the stage. Further complicating the task is that direct position feedback control is near-essential to control mobile element movement with the precision necessary in many modern stage environments.

Mobile element movement on stage may be further complicated by the presence of other moveable objects on the stage. Other moveable objects may include other mobile elements situated on the stage surface or moveable elements suspended above the stage surface controlled by the motion automation system. For suspended objects, avoiding collisions or interactions with supporting cables or ropes is equally important as avoiding collisions with the suspended object itself. Directing mobile and moveable element movement to avoid these other moveable objects using a master motion control system alone is complicated and lacks the precision required in modern staging design.

What is needed is a direct position feedback system for mobile elements on stage capable of precise spatial location of the mobile element in real time and recognition of obstacles to planned movements of the mobile element to improve the capability of the motion automation system as a whole. Additional benefits would be realized by a system that is easier to set up and calibrate.

### SUMMARY OF THE INVENTION

Accordingly, the present invention, in any of the embodiments described herein, may provide one or more of the following advantages:

In one embodiment, a system is provided for monitoring the position of a mobile element on a performance stage including a computer vision camera that captures images while the mobile element moves into multiple positions about the stage and converts the images to position data, and control system directing movement of the mobile element using position data. In some embodiments, the control system receives input data from a master control system defining a desired position or movement path and the control system compares the position data to the desired position or movement input data to direct movement of mobile element in conformity with the desired position or movement path.

In another embodiment, a system is provided for monitoring the position of a mobile element on a performance stage wherein a computer vision camera mounted on the mobile element for movement therewith and captures images while the mobile element moves into multiple positions about the stage and converts the images to position data. The stage may include an object located at a known fixed position on the stage and the computer vision camera converts images of the object into position data indicative of the mobile element position relative to the fixed position of the object.

In another embodiment, a system is provided for closed loop control and monitoring of the position of a mobile element on a performance stage wherein a computer vision camera mounted on the mobile element for movement therewith and captures images while the mobile element moves into multiple positions about the stage and converts the images to position data. The stage may include an object selected from the list of an object of known shape and size and a light source, located at a known fixed position on the stage the object and the computer vision camera converts images of the object into position data indicative of the mobile element position relative to the fixed position of the object.

In another embodiment, a system is provided for monitoring the position of a mobile element on a performance stage wherein a computer vision camera mounted on the mobile element for movement therewith and captures images while the mobile element moves into multiple positions about the stage and converts the images to position data. A control system receives the position data and directs movement of the mobile element in real time.

In another embodiment, a system is provided for monitoring the position of a mobile element on a performance stage wherein a computer vision camera is mounted in a known location on the stage and configured to capture images of the mobile element as it moves into multiple positions about the stage. The computer vision camera converts those images to real-time position data for use by a control system.

In another embodiment, the present invention provides a system for monitoring position of a mobile element on a performance stage wherein a computer vision camera captures images while the mobile element moves into multiple positions about the stage and converts the images to position data for use by a control system directing movement of the mobile element using the position data that is durable in construction, inexpensive of manufacture, carefree of maintenance, easily assembled, and simple and effective to use.

Other features and advantages of the present invention will be apparent from the following more detailed description of the preferred embodiment, taken in conjunction with the accompanying drawings which illustrate, by way of example, the principles of the invention.

### BRIEF DESCRIPTION OF DRAWINGS

The advantages of this invention will be apparent upon consideration of the following detailed disclosure of the invention, especially when taken in conjunction with the accompanying drawings wherein:

FIG. 1 shows a layout of a performance stage with a mobile element incorporating an embodiment of the present invention;

FIG. 2 shows a layout of a performance stage illustrating a mobile element in motion to demonstrate one embodiment of a direct determination of mobile element location determination;

FIG. 3 shows a layout of a performance stage and a second embodiment of the present invention; and

FIG. 4 provides a schematic diagram of a mobile element position monitoring and control system embodying aspects of the present invention.

Wherever possible, the same reference numbers will be used throughout the drawings to represent the same parts.

### DETAILED DESCRIPTION OF THE INVENTION

The embodiments described herein use a computer vision camera to provide location data to a control system within the entertainment industry. More specifically, a computer vision camera replaces position sensors, accelerometers, and rigging cable length measurements from the prior art. The computer vision camera determines location of mobile elements by directly viewing the environment around the mobile element and determining position of the mobile element in relation to the environment.

Computer vision is a field of computer science that trains computers and systems to interpret and understand the visual world. Computer vision allows computers and systems to derive meaningful information from visual inputs including, but not limited to, digital images and videos. The computers and systems react to the visual inputs they “see”, for example by taking actions or making recommendations based on that information.

Computer vision cameras convert the visual inputs they receive in the form of digital images and/or videos into data that can then be transferred to a computer or control system for processing. Exemplar computer vision cameras may include Intel Real Sense Depth Cam D405, Model No.82635DSD405 and Luxinos Oak-D, Model No. A00110-INTL. These computer vision cameras feature built-in image processing capability allow them to work with conventional small computer platforms, such as an AI Box Computer, Model No. EPC-R3720 by Advantach, or even an embedded computer processor incorporated in the motion controller. Numerous other hardware options with similar specifications are commercially available and may be utilized with equal effectiveness within the scope of this disclosed invention.

Applicant's pending application Ser. No. 18/083,984, CV Auto-Calibrated Bridle Method and System, filed Dec. 19, 2022, discloses a system and method for position monitoring of suspended moveable stage elements, the descriptive portions thereof are incorporated by reference herein.

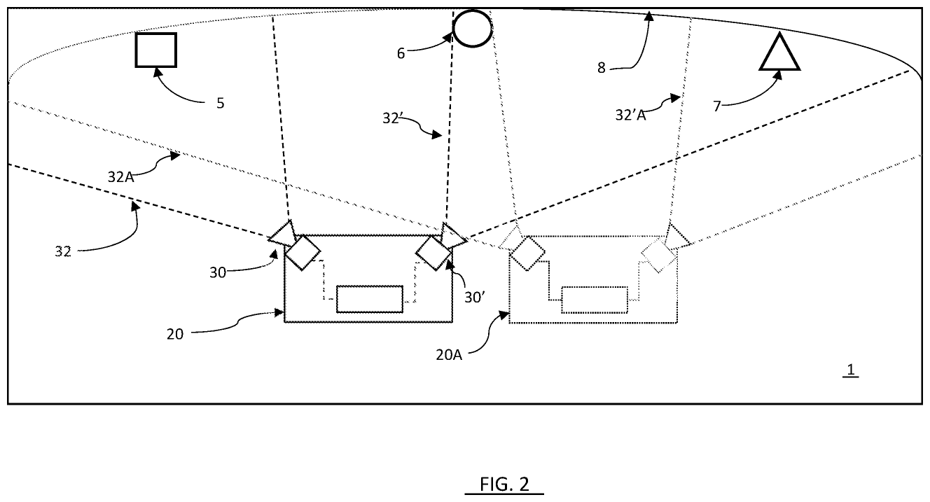

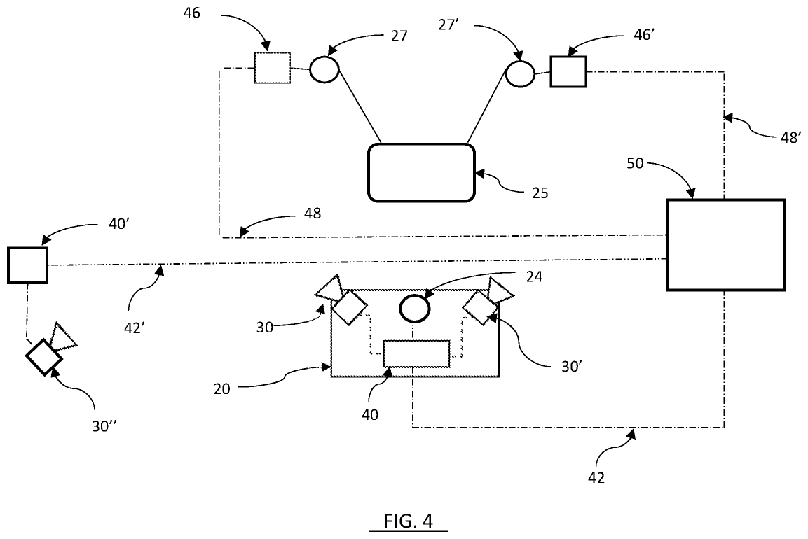

A system 10 is provided for monitoring the position of a mobile element 20 on a performance stage 1 in real time. The system 10 includes a computer vision (CV) camera 30 that captures images in real time while the mobile element moves into multiple positions (see FIG. 2) about the stage and converts the images to position data. A position control system 40 directs movement of the mobile element using input of the position data from the CV camera. The control system may be operably connected to one or more actuators 24 that move, propel, or steer the mobile element about the performance stage. A master control system 50 (FIG. 4) may be provided to communicate with the mobile element position control system as well as other discreet mobile element position control systems on the performance stage and coordinate movement of a plurality of mobile elements used in the stage production.

As used herein, the term “position” when referring to the mobile element means the location of the mobile element in three-dimensional space (x-, y-, and z-coordinates) and the orientation of the mobile element (rotation about the x-, y-, and z-axes). Position may be expressed or measured in other coordinate systems (e.g., vector coordinates) consistent with determining the mobile element position in six degrees and are contemplated within the scope of this disclosure.

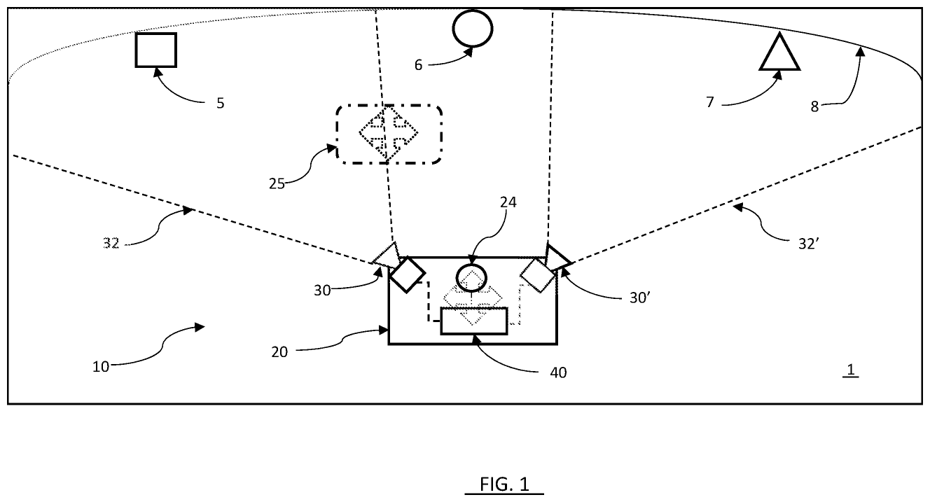

In one embodiment best illustrated in FIG. 1, a CV camera 30 and position control system 40 is mounted on the mobile element 20 for movement therewith. The CV camera is aligned so that its field of view 32 includes a portion of the performance stage in which one or more objects 5, 6, 7 of known, fixed dimension and location are situated. The CV camera 30 captures images of the one or more objects, converts the images into position data, inputs the position data into the position control system which calculates the position of the mobile element in relation to the one or more objects and therefore its position on the performance stage 1. The CV camera may include two or more cameras 30, 30′ to provide a second field of view 32′ which improves system redundancy and accuracy of the position determination.

The field of view is preferably directed toward the rear 8 of the performance stage where visually perceivable objects (e.g., scenery, backdrops, support structures) are more likely to remain stationary and in known locations compared to views toward the front of the stage which typically include performers or even an audience. As mobile element 20 moves from a first location to a second location (designated as 20A in FIG. 2), the field of view shifts to second location 32A and the CV cameras determine the position of the second location 20A based on the perceived locations of fixed objects 5 in the second field of view 32A.

Objects 5, 6, 7 on the performance stage may include objects having a known shape and size, visual targets, or a light source in the visible or infrared spectrum. The objects may include portions of the performance stage set which eliminates the need for visual targets which may not blend into the set. Similarly, light sources in the invisible spectrum may be used without affect the audience view of the performance stage.

The CV camera may also capture images of another moveable object 25 within its field of view, convert the images of the moveable object into position data, input the position data into the position control system which calculates the changes in position of the other moveable object in relation to the mobile element CV camera. This position and movement data may be used by position control system 40 to manage operation of actuator 24 thereby controlling movement of the mobile element and preventing unintended collisions with other moveable objects on the performance stage.

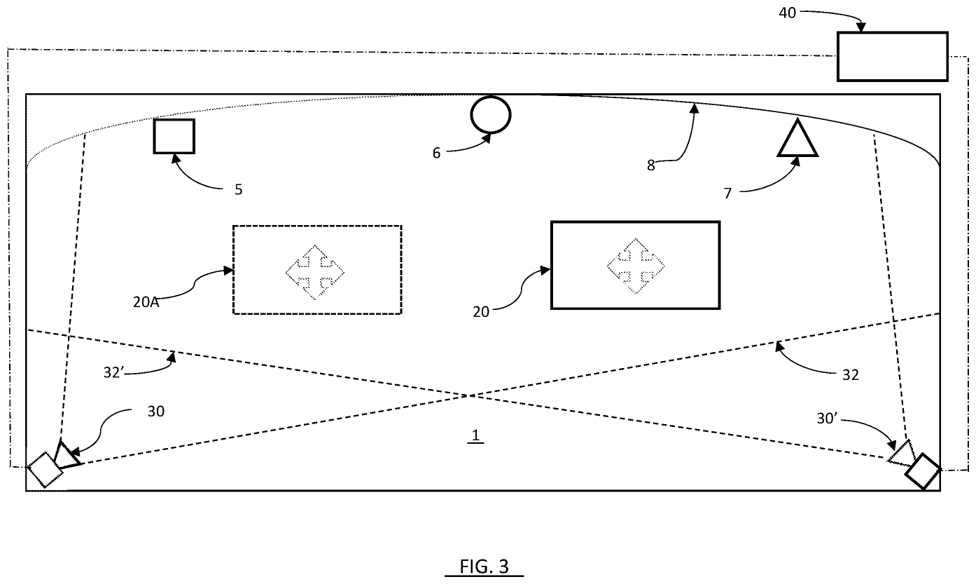

In another embodiment best illustrated in FIG. 3, a CV camera 20 is mounted in a fixed location in relation to the stage. A control system 40 is also provided to receive position data from the CV camera. Control system 40 may manage movement of the mobile element, particularly if the mobile element is suspended above the stage by a rigging system and movement thereof caused by coordinated action of a plurality of hoists. The CV camera is aligned so that its field of view 32 includes a portion of the performance stage in which one or more mobile elements of known configuration may be situated. The CV camera 20 captures images of the mobile element, converts the images into data, inputs the data into the control system which calculates the position of the mobile element in relation to the camera location and therefore the mobile element's position on the performance stage to prevent collision with other objects on the stage and consequential damage.

One or more objects 5, 6, 7 of known location and dimension may be situated on the performance stage in the field of view of the CV camera to improve the accuracy of the position determination. The CV camera 30 may include two or more cameras to provide system redundancy and improve accuracy of the position determination.

The CV camera may include two or more cameras 30, 30′ to provide a second field of view 32′ which improves system redundancy and accuracy of the position determination.

One method for determining the position of a suspended moveable element relies on hoist encoders to know to know the length of each rope to determine the position of suspended element. CV camera 30 and control system 40 enables system 10 to provide real-time position information for the moveable element, not just where the element is predicted to be based on the configuration of the suspension arrangement.

Now referring to FIG. 4, a master control system 50 may be provided to communicate with a plurality of control systems 40, 40′, 46, 46′ used for managing movement of a plurality of mobile elements 20, 25 on the performance stage used in the stage production. The plurality of mobile elements may include a first mobile element 20 having an on-board CV camera 30 and control system 40 managing an actuator 24 to direct movement of the mobile element on the performance stage through actuator 24. The plurality of mobile elements may also include a second mobile element whose position is monitored by a stationary CV camera 30″ to direct movement of the mobile element by managing actuators 27, 27′. Additional controllers 46, 46′ may be provided to receive position information from stationary CV camera 30″ and direct movement of actuators 27, 27′ and thereby direct movement of second mobile element 25 in relation to the performance stage. The control systems receive position data from respective CV cameras 30, 30′, 30″ and may communicate position information for mobile elements 20, 25 to the master control system 50. Master control system 50 may also be operably configured to coordinate movement of the plurality of mobile elements 20, 25 on the performance stage by directing such movement and using the respective CV cameras and position control systems to monitor mobile element position to assure conformity with the planned motion and prevent unintended collision between mobile elements or any associated rigging.

Master control system 50 may communicate with the control systems via signal pathways 42, 42′, 48, 48′. The signal pathways connecting master control system 50 to the respective individual control systems may be wired or wireless.

A method of using a system 10 for monitoring and controlling a mobile element on a performance stage includes equipping a mobile element 20 with a computer vision (CV) camera 30 and a position control system 40. The CV camera is aligned so that its field of view 32 includes a portion of the performance stage in which one or more objects 5, 6, 7 of known, fixed dimension and location are situated. The CV camera 30 captures images of the one or more objects as the mobile element 20 moves about the stage, converts the images into position data, inputs the position data into the position control system which calculates the position of the mobile element in relation to the one or more objects and therefore its position on the performance stage 1. The position control system 40 may be operably coupled to an actuator 24 for propelling the mobile element 20 about the stage. The position control system 40 may be provided with instructions for moving the mobile element about the stage. The CV camera may detect obstacles to the mobile element movement instructions and input associated position data into the position control system. The position control system may, upon detection of obstacles to movement instructions, alter the motion of the mobile element, take it to a safe location, or a combination thereof.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A system for monitoring real-time position of a mobile element on a performance stage comprising:
a mobile element;
a computer vision camera that captures images while the mobile element moves into multiple positions about the stage and converts the images to position data;
a control system directing movement of the mobile element using position data.

2. The system of claim 1, wherein the computer vision camera is disposed on the mobile element for movement therewith and the captured images include views of the stage.

3. The system of claim 2, wherein the computer vision camera comprises at least two computer vision cameras.

4. The system of claim 3, further comprising an object located at a known fixed position on the stage, the computer vision camera converting images of the object into position data indicative of the mobile element position relative to the stage.

5. The system of claim 4, wherein the object is selected from the list of an object of known shape and size, and a light source.

6. The system of claim 1, wherein the control system receives input data defining a movement plan and the control system compares the position data to the movement plan to direct movement of mobile element consistent with the movement plan.

7. The system of claim 6, further comprising a master control system communicatively coupled to the control system to provide the movement plan to the control system.

8. The system of claim 1, wherein the control system is configured to identify moveable objects on the stage from the images, determine position data in relation to the mobile element, and direct mobile element movement to avoid unintended contact with moveable object.

9. The system of claim 1, wherein the computer vision camera is disposed on the stage and the captured images are viewing the mobile element.

10. The system of claim 9, further comprising an object located at a known fixed position on the stage, the computer vision camera converting images of the object into position data indicative of the mobile element position relative to the stage.

11. The system of claim 9, wherein the control system receives input data defining a movement plan and the control system compares the position data to the movement plan to direct movement of mobile element consistent with the movement plan.

12. The system of claim 11, further comprising a master control system communicatively coupled to the control system to provide the movement plan to the control system.

13. A method for monitoring the position of a mobile element on a performance stage comprising the steps of:
mounting a computer vision camera on the mobile element that captures images of objects on the stage;
moving the mobile element into multiple positions on the stage as the computer vision camera captures images of objects on the stage; and
converting the computer vision camera images to position data corresponding to the multiple positions on the stage.

14. The method of claim 13, further comprising the step of:
providing a control system configured to receive the position data and determine an instruction to cause a desired movement of the mobile element.

15. The method of claim 14, wherein the location of objects on the stage is known.

16. The method of claim 15, further comprising the step of:
configuring the control system to identify from the images a moveable object on the stage, determine position data for the moveable object in relation to the mobile element, and direct mobile element movement to avoid unintended contact with the moveable object.

17. The method of claim 16, wherein the computer vision camara comprises two or more computer vision cameras.
